(19) United States
(12) Patent Application Publication
(10) Pub. No.: US 2010/0275144 A1
(43) Pub. Date: Oct. 28, 2010

(54) HIGHLY VISUAL DRAG AND DROP METHOD TO SIMPLIFY PROGRAMMING SPECIAL PAGES

(75) Inventors: Evangeline C. Dejoras, Cerritos, CA (US); Andrew S. McVey, Redondo Beach, CA (US)

Correspondence Address: Ronald F. Chapuran;Patent Documentation Center, Xerox Corporation, 100 Clinton Avenue South, Xerox Square, 20th floor, Rochester, NY, 14644, US

(73) Assignee: Xerox Corporation, Norwalk, CT (US)

(21) Appl. No.: 12/430,917

(22) Filed: Apr. 28, 2009

(51) Int. Cl. G06F 3/048; G06F 17/00

(52) U.S. Cl. 715/769; 715/838; 715/273

(57) ABSTRACT

The present disclosure shows an easy to learn and easy to use drag and drop method in a highly visual user interface to simplify the process of programming special pages and to quickly add page objects to a document's pages. The results of these drag and drop operations are displayed for the user prior to printing. More specifically, a limited number of icons are preprogrammed but can be pre-programmed when applied to a document. The modifications apply to subsequent applications of the icon to provide a simple but flexible technique to accommodate numerous types of special page programming. It also provides the ability to save modifications relative to the page reference, thus making the special pages programmed reusable and useful even if the original document has been somewhat modified.

### BACKGROUND AND SUMMARY

1. Field of the Technology

The present disclosure is applicable to methods and systems of programming special features in production printing. Special feature programming requires users to build a table of exceptions by entering page numbers and specifying the exceptions for those pages using a dialog.

2. Description of the Prior Art

In the prior art, generally the user must build a list of exceptions in a job submission dialog. The user selects the desired exception. In the dialog window, the user enters a page number or range, and sets up parameters specific to that exception.

One difficulty in methods of programming special pages and features in current printing systems is the requirement that users build a table of exceptions by entering the page numbers and specifying the exceptions for those pages using a dialog. Users do not have a view into the content of the pages during job submission. To get this task done with reasonable success, the user must inspect the document prior to submission and prepare a list of pages and their required exceptions, or remember exactly which pages (page numbers) needed to be setup as special pages. If some pages need to be made 1-sided, the user opens a dialog and enters the page numbers that are to be made 1-sided. If a job requires tab inserts, a dialog is opened, and the user enters the page numbers after which, or before which, the tabs are to be inserted. Depending on the implementation of the software, some of the dialogs allow a single page number to be entered, and some allow multiple page numbers. Some dialogs allow multiple exceptions to a page in one dialog, others require opening several dialogs, Users do not see the outcome of the special pages programming until the job is printed. This makes special pages programming subject to errors.

Another difficulty in the current exception feature and page programming systems is the task of adding page objects to a document such as page numbering, watermarks, barcodes, date stamps and text prior to printing. Generally, the user must enter settings in a dialog to enable and specify the characteristics of the object each time it is applied. A preview may be provided or not depending on the software. The task of adding page objects is cumbersome because of the manual entry required. It is also error prone because the pages must be printed to proof the page objects. The key shortfall is the absence of a more direct way to add the objects such that the user can complete the task in fewer steps and get immediate visual feedback on how the object will print.

For example, in some systems, a preset text watermark can be turned on. Text is applied to the document's pages in a preset location. There is no positional control, and page selection is limited. A sample generic page is provided, but one cannot preview the watermark as applied to every page. In other systems, the user can specify any text or image as a watermark. It offers more position controls, but the page selection and the position controls are entered manually. The user cannot preview how the watermark is applied to every page and must print a proof to check it.

This invention builds upon an existing concept disclosed in Patent Application Publication US 2007/0133032A1, assigned to the same assignee as the present invention, in which page exception icons are programmed, and then dropped onto individual page representations. The focus of the existing concept is on the programming of the icon, that is, special programming as applied to pages only, and presents dragging and dropping of a pre-programmed icon onto a page to apply the program to it. It does not address special programming which requires pages as a reference, but which does not require the programming to be applied to the page itself. The concept also does not address the practical problem of dealing with the numerous types of exceptions that may need to be programmed, and therefore implies an unlimited number of icons that a user can define to represent various special programming attributes.

The present invention significantly improves the concept of the cited publication by providing a drag and drop method to program special pages which uses a document page as a reference but does not apply the programming to the page itself. A specific application for this is a tab insert or a sheet insert. It also provides a use model whereby a limited number of icons are pre-programmed and, once applied to a document, can be modified. The modifications can be applied in subsequent applications of the icon. This allows for a use model that is simple, but has the flexibility to accommodate numerous types of special page programming. It also provides the ability to save the inserted sheets relative to the page reference, thus making the special pages programmed reusable and useful even if the original document has been somewhat modified.

### SUMMARY OF DISCLOSURE

The invention utilizes an easy to learn and easy to use drag and drop method in a highly visual user interface to simplify the process of programming special pages and to quickly add page objects to a document's pages for printing jobs. The results of these drag and drop operations are displayed for the user prior to printing. Also, these results can be saved in a template for use in future jobs or modified for use in future jobs.

### BRIEF DESCRIPTION OF THE DRAWINGS

The above described features and advantages of the present disclosure will be more fully appreciated with reference to the detailed description and appended figures in which:

FIG. 1 illustrates a prior art exception programming screen window with no job exception shown.

FIG. 2 shows a prior art insert dialog window.

FIG. 3 depicts the prior art exception programming screen window with job exception shown.

FIG. 4 illustrates a preview area displaying page thumbnails and a row of icons related to the thumbnails in accordance with the present invention.

FIG. 5 illustrates a tab insert in a drag and drop operation between two sheets.

FIG. 6 shows a tab insert thumbnail added between two existing thumbnails.

FIG. 7 illustrates a tab insert property dialog.

FIG. 8 shows a change to the tab insert properties dialog.

FIG. 9 illustrates the change of properties on the thumbnail.

FIG. 10 illustrates multiple insertion points for insertion icons.

FIG. 11 shows the addition of multiple thumbnails for multiple insertion icons.

FIG. 12 depicts saving insertions as part of a template.

FIG. 13 depicts reusing the template or a modified version of the template.

FIG. 14 shows a preview area for adding page objects to a page.

FIG. 15 illustrates a watermark in a drag and drop operation to a page.

FIG. 16 depicts a watermark after a drop operation on a page.

FIG. 17 illustrates a watermark dialog window to make changes.

FIG. 18 and FIG. 19 illustrate page numbering being placed where a user drops a page numbering icon.

### DETAILED DESCRIPTION

The first aspect of the present invention addresses the cumbersome and error-prone nature of special page programming. In this aspect, thumbnails of the pages that comprise the job are presented in a preview area. A row of special page features is presented above the preview area in the form of icons. By looking at the thumbnails, users can visually identify the special pages that require programming and can program the pages by picking up a pre-programmed special page icon and dragging and dropping it onto a target. The user can drag and drop these icons onto or between the page thumbnails in order to define special pages. The alternative is remembering specific page numbers within their job, and entering the page numbers in a dialog without seeing the content of the page for verification.

In the second aspect of the present invention, users are provided a drag and drop method to add page objects to a document. A large view of every page in the document is presented in a Page View. Barcodes, bates stamp, page numbers, text, and image watermarks can be added directly to one or more pages by dragging icons that represent these objects onto the desired location on the visible page. In one step, the user is able to put the object in the desired location on the page. Some of these objects come with pre-programmed values, as in the case of page numbering where common practices are known, and therefore do not need to be setup. The programming can be modified after it is dropped. Other objects have to be setup such as the case of a barcode where practices vary significantly. The page range upon which the objects are applied differs: from one object to another depending on the most frequent use case. Some objects are applied to all pages by default, such as page numbering and bates stamps. Others are added only to the page that received the object as in the case of a barcode. Instances of the object on a page can be deleted selectively, or all at once. Objects can be moved, and some of them can be resized. As these operations are done, the user sees the results in real time.

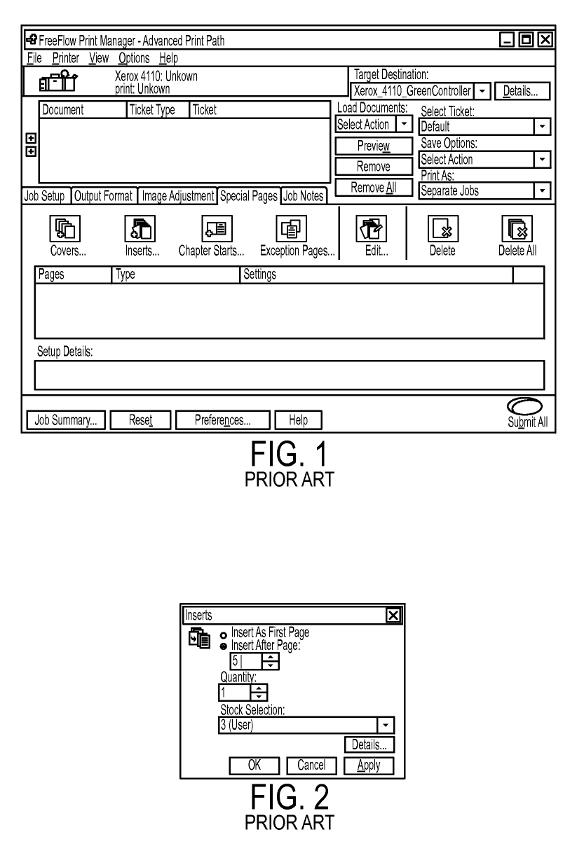

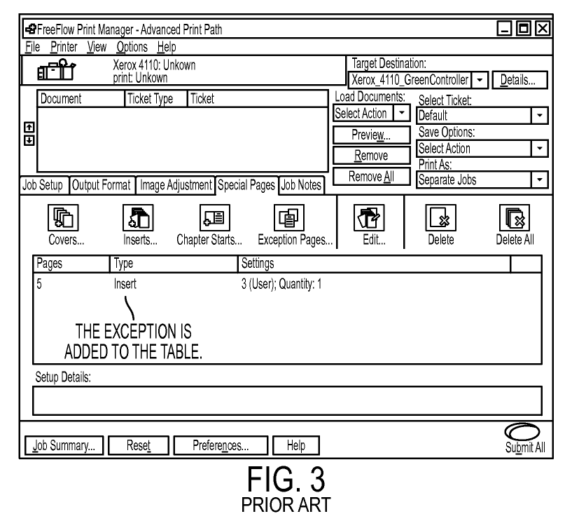

With reference to FIG. 1, there is shown a prior art system having a screen window and job modification icons, specifically covers, inserts, chapter starts, and exception pages. Initially, the window has no job modification shown. As an example operation, a user clicks on the inserts icon and opens the insert dialog window shown in FIG. 2. The user then must specify the pages and parameters required, that is, an insert after page 5, the stock selection being identified as 3 (user). The programmed exception is then shown in the window below the icons as shown in FIG. 3. If this entry requires revision, the user selects it and makes revisions in the dialog window. Any changes will be reflected in that table entry. The user repeats this process of clicking on a desired job modification and entering the page number and property for the next exception, one page at a time until all the exceptions are manually entered.

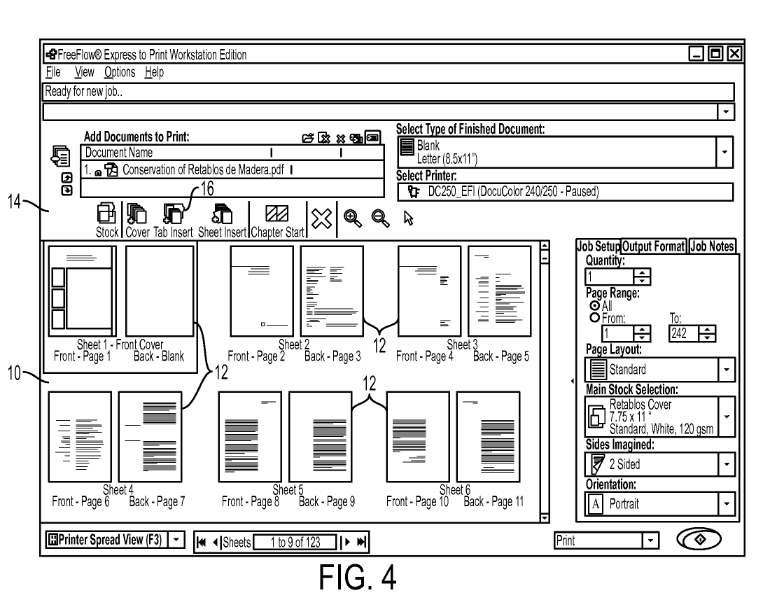

According to one aspect of the present invention, there is provided a preview area in which the user can see thumbnails of the pages or documents that comprise the job. The page exception features are represented by icons located above the preview area. As illustrated in FIG. 4, there is shown a preview area, window 10, displaying page thumbnails generally shown at 12 and a row of icons 14 above the thumbnails 12 including tab insert icon 16.

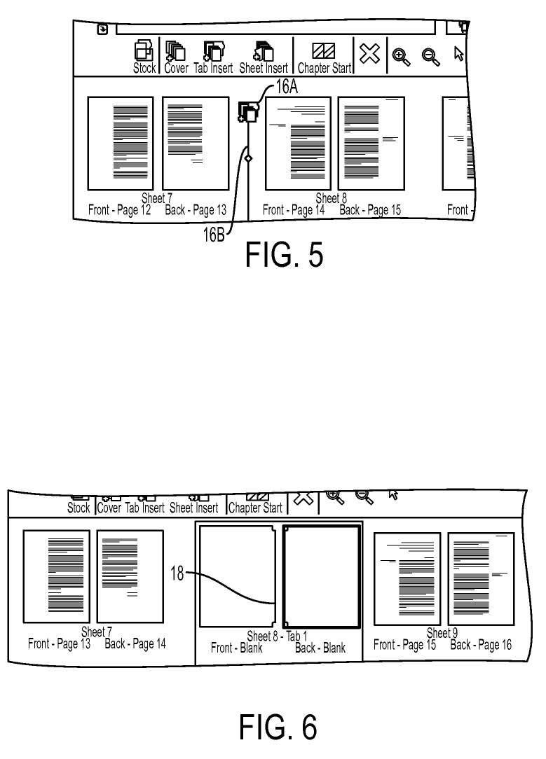

One example, according to the present invention, is adding tab inserts between specific sheets of a document. This is done by dragging the icon 16 and dropping it between the appropriate thumbnails for the tab insert. With reference to FIG. 5, there is illustrated a tab insert icon 16A being dragged between thumbnails representing sheets 7 and 8 to an arbitrary location as shown at 168.

As shown in FIG. 6, once the tab insert icon 16A has been dropped between sheet 7 and sheet 8, a new thumbnail 18 is created to represent the tab insert that has just been dragged and dropped. The new thumbnail 18 illustrates the tab insert with default settings as sheet 8, between Sheets 7 and 9: The inserted object (tab insert) uses sheet 7, page 13, as the reference. Page 13 does not change as a result of this insertion. However, as shown, the previous sheet 8, pages 14 and 15, is now sheet 9, pages 14 and 15. The tab insert always follows the sheet where page 13 lands.

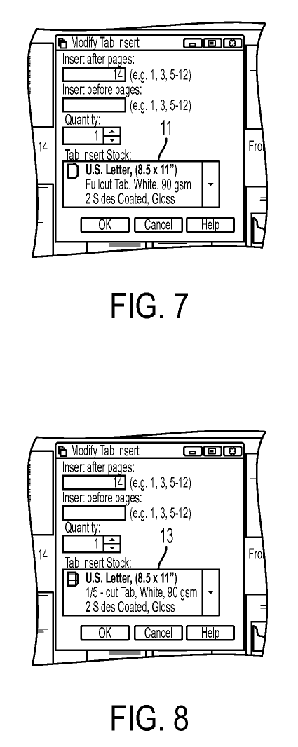

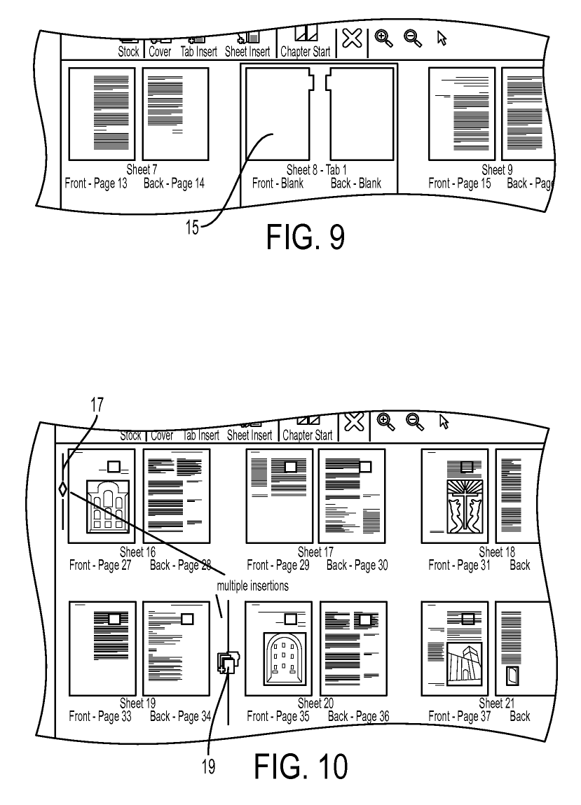

As mentioned above, a significant feature of the present invention over the prior art is the capability to change the properties of an exception feature that has been applied directly to a page, for example, stock properties. In other words, the prior art does not enable the user to modify or tweak an exception that has been dropped. This is illustrated in FIGS. 7, 8, and 9. If the user wants to change the properties of the tab insert, the user double clicks on the inserted tab and the tab insert's property dialog opens. The user can then make insert tab property changes such as providing a 1/5-cut tab insert rather than a full-cut tab. FIG. 7 illustrates the property dialog before the change, identifying the insert stock to be full-cut tab as shown at 11. FIG. 8 illustrates that the user has selected a 1/5-cut tab as shown in the property dialog at 13. This change is then reflected in the thumbnail illustrated in FIG. 9 at 15, with the thumbnail being a 1/5-cut tab rather than a full-cut tab.

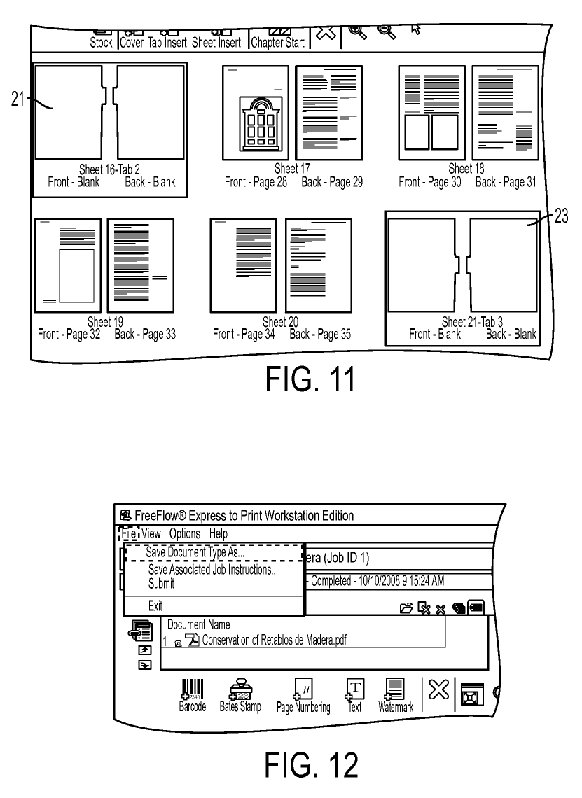

Multiple insertion points are supported for various features. For example, the user selects multiple points by holding down a CTRL key, or other suitable switch, while selecting an insertion such as Stock, Cover, Tab Insert, and Sheet Insert as shown in the row of icons 14, then drags the selected icon to various insertion points as illustrated in FIG. 10 at 17 and 19. The selected icon is then added as thumbnails at the insertion points. The properties of the type of icon used for the last insertion are applied, and the correct icon positions are calculated based on the previous icon inserted as illustrated in FIG. 11 at 21 and 23.

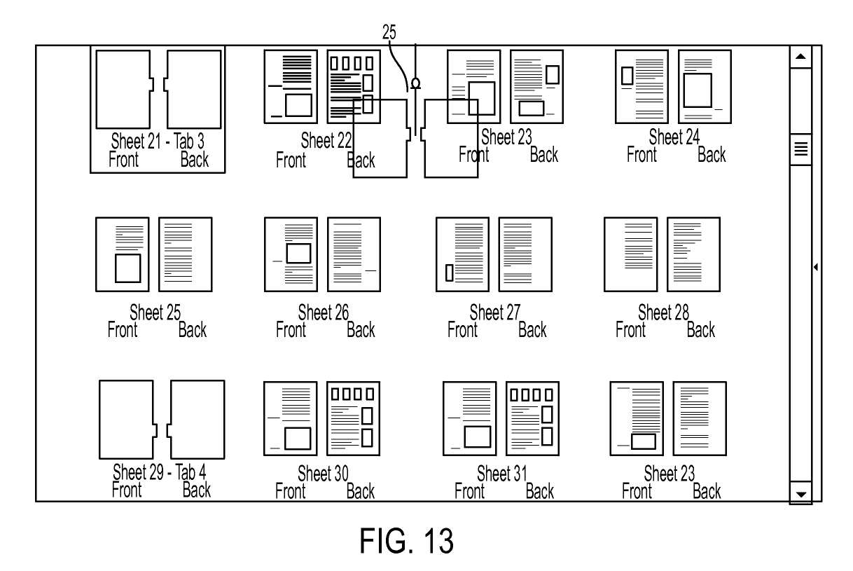

The inserted tabs can be saved as part of a template as shown in FIG. 12. The user can reuse this template for the same job, or a modified version of the job. If a job is modified (e.g., new pages added), the tab location may be incorrect relative to the content of its page reference. The user can simply drag the tab to the new location. This is illustrated in FIG. 13 at 25. Specifically, sheet 21 becomes Tab 3 as a result of the multiple insertion as shown in FIG. 10. The user saves the exceptions to a template as shown in FIG. 12. In FIG. 13, the user has selected the saved template and brought in a version of the Retablos document. In this version, two new pages have been added after page 35 as shown in FIG. 11 by the document creator. Since Tab 3 uses page 35 as a reference, it appears between page 35 which is on sheet 20 and the two new pages on sheet 22. Tab 3 is out of order. To fix this, simply drag Tab 3 after sheet 22. This is in place of programming a new set of tabs for the modified document.

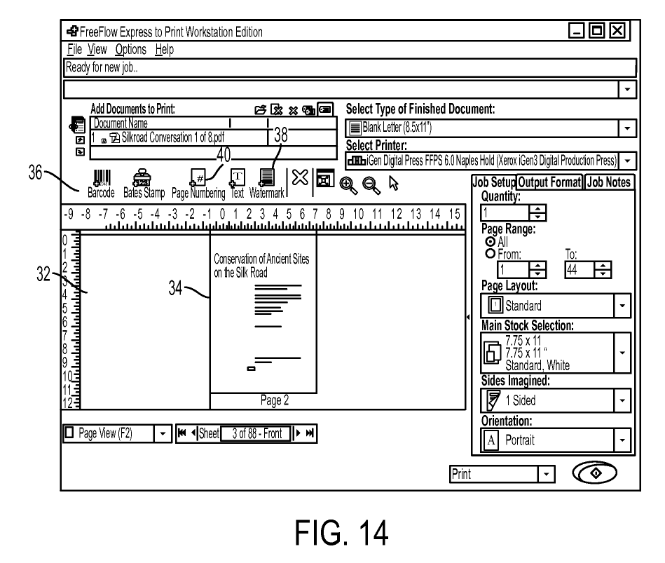

Another aspect of the present invention is adding a page object to a page to the document job. The user drags one of plurality of page object icons such as Barcode, Bate stamp, Page numbering, Text, and Watermark onto a page image. With reference to FIG. 14, there is shown a preview area, window 32, including a page image 34 and a row of page object icons 36. As an example of this aspect of the invention, a watermark 38, as shown in the row 36 of page object icons, will be added to page image 34, representing page 2 of the document job.

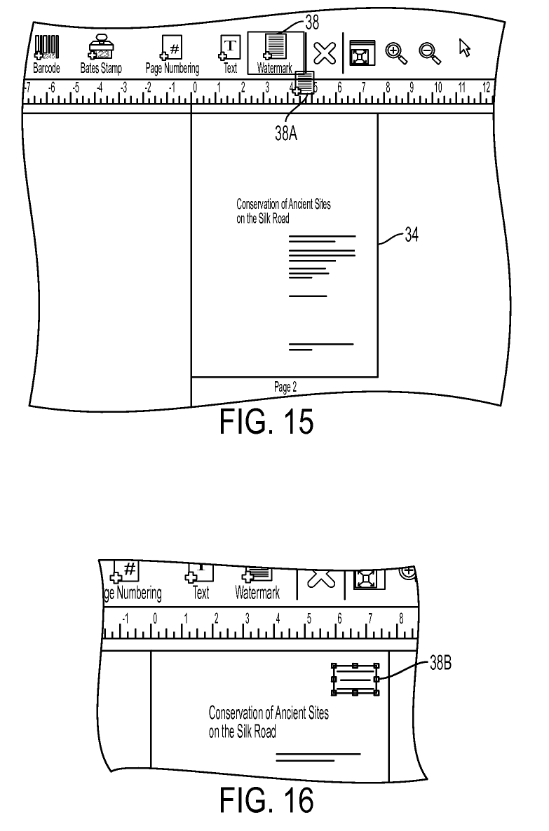

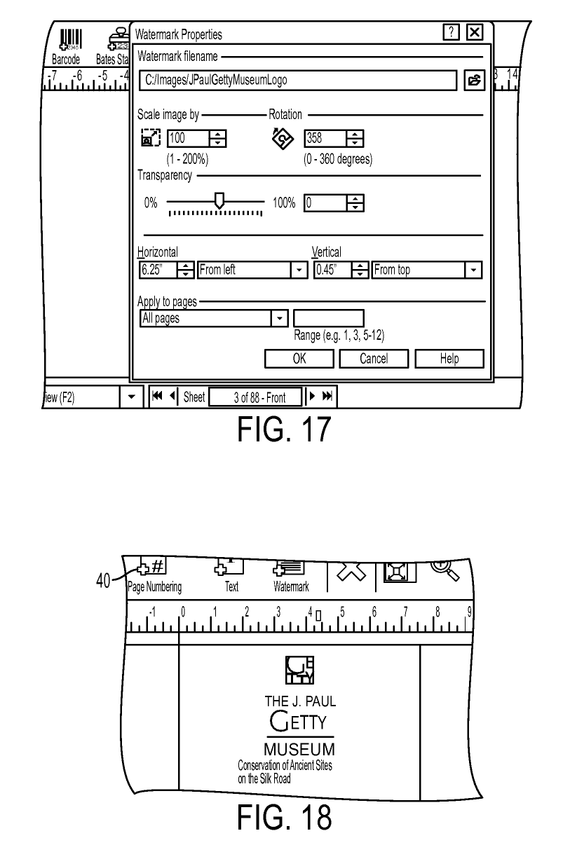

In particular, FIG. 15 illustrates a phantom watermark icon 38A being dragged toward page image 34 and FIG. 16 illustrates the watermark, graphic 38B, being placed where the user “drops” the watermark icon 38A. The watermark dialog opens when the user double clicks the watermark graphic. Changes can then be made to the watermark properties box, as shown in FIG. 17. For example, the watermark graphic can be scaled, rotated, and applied to selected pages.

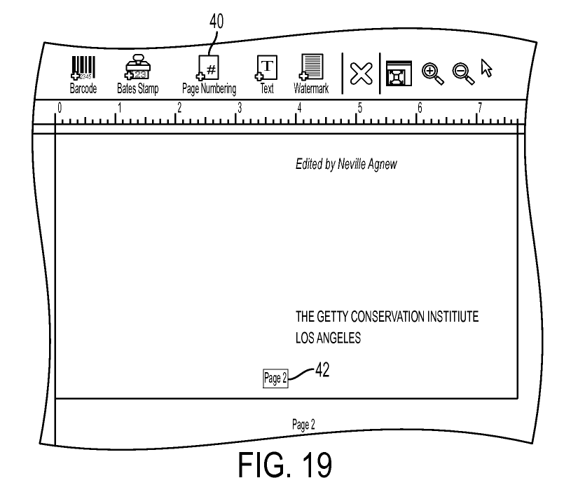

Another example of this aspect of the present invention is page numbering. FIGS. 18 and 19 illustrate page numbering being added to the document job. For example, a user can simply drag and drop a page numbering icon 40 (FIG. 18) to a location on a page where numbering is desired. FIG. 19 illustrates (at 42) that the page numbering icon has been dropped at the bottom of the page. The icon is preset to Page 1 and all pages are numbered by default starting with Page 1 on the first page of the document. No setup is necessary if the default meets the specific requirement of the job.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method of programming exception features in a document processing job, comprising the steps of:
providing a preview area on a user interface screen, including a display of a set of thumbnails of the documents of the document processing job,
representing exception features related to the document processing job by a set of icons located on the interface screen in relation to the set of thumbnails, and
dragging a selected icon from the set of icons on the interface screen and dropping the selected icon in a suitable location with respect to the set of thumbnails on the interface screen to provide an exception feature as indicated by the selected icon for the document processing job.

2. The method of claim 1 wherein the step dragging a selected icon from the set of icons on the interface screen and dropping the selected icon in a suitable location with respect to the set of thumbnails on the interface screen includes the step of dragging an icon representing a document insert and dropping it between selected thumbnails of the documents representing the document processing job on the interface screen.

3. The method of claim 1 wherein the exception features include inter-document features including the step of successively dragging an icon representing inter-document features and dropping the icon between multiple selected thumbnails to provide multiple inter-document features in the document processing job.

4. The method of claim 3 wherein the inter-document feature icons represent cover, tab, and sheet inserts.

5. The method of claim 1 including the step of automatically adding a new thumbnail to the set of thumbnails comprising the document processing job in response to the placement of the selected icon.

6. The method of claim 5 wherein the new thumbnail has properties and including the step of activating the new thumbnail on the user interface screen to provide a change of properties.

7. The method of claim 6 wherein the step of activating the new thumbnail on the user interface screen includes the step of clicking on the thumbnail.

8. A user interface device for providing exception features in a document processing job, comprising:
memory for storing data of the document processing job,
a processor for changing the data of the document processing job,
a user data input control for entering new data to the processor in relation to the document processing jobs
an interface screen for displaying a set of thumbnails of the documents of the document processing job and displaying a set of document job exception icons, and
means for positioning selected document job exception icons with respect to the thumbnails on the interface screen by the data input control to provide exception features in the document processing job.

9. The user interface device of claim 8 wherein the means for positioning selected document job exception icons with respect to the thumbnails on the interface screen by the data input control includes means to represent document inserts between selected thumbnails.

10. The user interface of claim 8 including means to automatically provide a new thumbnail to the set of thumbnails on the interface screen in response to the means for positioning.

11. The user interface of claim 10 wherein the new thumbnail has properties and including means to selectively change the properties.

12. The user interface of claim 8 including means for representing multiple job exception icons with respect to multiple thumbnails on the interface screen.

13. A method of providing exception features in a document processing job, comprising the steps of:
displaying on a user interface screen a set of thumbnails of the documents of the document processing job,
displaying exception features related to the document processing job by a set of icons located on the interface screen in relation to the set of thumbnails, and
representing a selected icon from the set of icons on the interface screen with respect to the set of thumbnails on the interface screen to provide an exception feature as indicated by the selected icon for the document processing job.

14. The method of claim 13 wherein the step representing a selected icon from the set of icons on the interface screen includes the step of positioning the selected icon with respect to selected thumbnails of the documents representing the document processing job on the interface screen.

15. The method of claim 13 wherein the exception features include inter-page features including cover, tab, and sheet inserts.

16. The method of claim 13 wherein the exception features include intra-page features including page numbering and watermarks.

17. The method of claim 14 including the step of adding a new thumbnail to the set of thumbnails comprising the document processing job in response to the positioning of the selected icon.

18. The method of claim 17 wherein the new thumbnail has properties and including the step of activating the new thumbnail on the user interface screen to provide a change to the properties.

19. The method of claim 18 wherein the step of activating the new thumbnail on the user interface screen includes the step of clicking on the thumbnail.

20. The method of claim 13 including the step of saving exception features in a template for use in another document job.

21. The method of claim 20 including the step of modifying the exception features in the template for use in another document job.

22. A method of programming exception features in a document processing job, the exception features including intra-page exception features inherent to specific documents of a document processing job and to inter-page exception features identified with relationships of specific documents of the document processing job, comprising the steps of:
providing a preview area on a user interface screen,
displaying on the interface screen a set of thumbnails of the documents comprising the document processing job,
representing exception features related to the document processing job by a set of icons located on the interface screen in relation to the set of thumbnails, and
dragging a selected icon from the set of icons on the interface screen and dropping the selected icon in a suitable location with respect to the set of thumbnails on the interface screen to provide an exception feature as indicated by the selected icon for the document processing job.

23. The method of claim 22 wherein the step of dragging a selected icon from the set of icons on the interface screen and dropping the selected icon in a suitable location with respect to the set of thumbnails on the interface screen includes the step of dragging an icon representing an inter-document exception feature and dropping it between selected thumbnails of the documents representing the document processing job on the interface screen.

24. The method of claim 22 including the step of successively dragging an icon representing an inter-document exception feature and dropping it between multiple selected thumbnails.

25. The method of claim 22 including the step of successively dragging an icon representing an intra-page exception feature and dropping it at selected locations within the thumbnails.

26. The method of claim 22 including the step of adding a new thumbnail to the set of thumbnails comprising the document processing job in response to the selected icon.
